(19) United States
(12) Patent Application Publication
(10) Pub. No.: US 2006/0263646 A1
(43) Pub. Date: Nov. 23, 2006

(54) Reverse electrodialysis for generation of hydrogen

(76) Inventor: Joseph B. Seale, Gorham, ME (US)

Correspondence Address: Nils Peter Mickelson, 228 Waterman Road, Buxton, ME, 04093, US

(21) Appl. No.: 11/437,603

(22) Filed: May 20, 2006

Related U.S. Application Data
(60) Provisional application No. 60/683,281, filed on May 21, 2005.

(51) Int. Cl. H01M 8/16; H01M 8/10; C25B 1/02

(52) U.S. Cl. 429/2; 429/38; 429/32; 205/637

(57) ABSTRACT

A system combines reverse electrodialysis and electrolysis to produce hydrogen gas from the controlled mixing of fresh and salt water. A battery stack is formed of alternating membranes of selectively cation-permeable and anion-permeable membranes. Alternating solutions of fresh and salt water flow between the alternating membrane types, causing cations to flow in one direction and anions in the opposite direction, generating a current and cumulative voltage through the stack—this is reverse electrodialysis. The ends of the stack are terminated in electrodes which are shorted together. A recirculating reagent solution flows back and forth between the cells adjacent to the end electrodes, promoting a hydrogen-producing electrolysis and avoiding generation of unwanted chemicals, for example, chlorine. Alterations in the reagent can cause production of antimicrobial compounds for cleansing the membranes. Periodic polarity reversals reduce membrane scale buildup and enhance efficiency.

### FIELD OF THE INVENTION

The invention relates to apparatus and methods for reverse electrodialysis of water for energy generation. It relates more particularly to harnessing the release of free energy associated with mixing of concentrated and dilute solutions of ionic salts, including the mixing of sea water with fresh water, with the end product being molecular hydrogen gas. The invention further relates to integrated anti-biofouling cycles and polarity reversals for maintaining reverse electrodialysis equipment.

### BACKGROUND OF THE INVENTION

It is well known that energy must be invested to separate a salt solution into fresh water and a more concentrated brine solution. In parts of the world lacking fresh water but having energy resources, energy is invested to provide fresh water and byproduct brine starting from brackish or salt water. Though large scale desalination is often performed mechanically, ionic compounds are also removed from water electrolytically. Desalination processes sometimes employ membranes with selective permeability, including so-called bipolar membranes. A common form of selective membrane permeability is preferential permeability to positive ions over negative ions and vice versa, of negative ions over positive ions. Electrical desalination of water is referred to as electrodialysis. This invention concerns the inverse process, reverse electrodialysis, to recover energy. The “reverse electrodialysis” principle employed in the present invention should not be confused with “electrodialysis reversal,” which is a technique to combat scale buildup on selectively-permeable membranes used for desalination. The present invention uses both “reverse electrodialysis” and “electrodialysis reversal” in its operation.

The reverse process of desalination of water, namely controlled mixing, can in principle yield energy in electrical or mechanical form. Tremendous amounts of recoverable energy are lost to the entropy of mixing of fresh and salt water where rivers empty into the ocean. This energy loss is equivalent to a hydrostatic head loss on the order of 250 meters height, approximately the energy-per-volume for water behind the world's highest dams. There has not existed, however, a practical large-scale approach to recovery of this lost energy, a loss that has heretofore escaped common recognition. Mechanical energy recovery using osmotic pressure was taught by Jellinek (U.S. Pat. No. 3,978,344), though for significant power output the process requires large membrane areas containing high hydrostatic pressures, plus means to convert the resulting hydraulic energy to a more portable form such as electricity. Norway's independent research organization SINTEF, working with the power company Statkraft, has built two small-scale demonstration plants of this sort. An impediment to further development in this area has been the high cost per kilowatt of capacity. A more complicated mechanical apparatus, involving highly concentrated salt brine and a steam turbine, as taught by Assaf et al, (U.S. Pat. No. 5,755,102), is of limited utility since few locations in the world provide the needed input of highly concentrated salt brine.

There is limited reporting of practical electrical energy recovery from electrical potential differences across ion-selective membranes. The science involved has long been understood, as reported for example in “Electric Power From Differences In Salinity”, Science, Feb. 13, 1976, Vol. 191, pp 557-9. As for practical demonstrations of electricity generation, one example comes from Knyazhev (Valerii V. Knyazhev, Laboratory of Unconventional Power, Vladivostok, Russia; an English-language article: http://www.informauka.ru/eng/2001/2001-07-13-0267_e.htm), who reported limited electricity production in 2001. More recently, Post (Jan Post, Wetsus, http://www.wetsus.nl/eng/Themes5b.htm) described a brine-driven electricity generation experiment in the Netherlands. The Knyazhev and Post references provide only very limited information. Post reports using oxidation and reduction of iron ions between the ferrous and ferric states to support electrode currents, thus avoiding electrolysis and avoiding the associated voltage drop, with the goal of maximizing power output as electricity.

Until recent developments in hydrogen fuel cell technology, electrolysis of water into hydrogen and oxygen was avoided as an energy-wasting byproduct of electrodialysis: there was no practical use for the hydrogen, which was regarded merely as an explosion hazard. This avoidance of electrolysis applied both to water purification and to electrical power generation: see Justi and Wensel, “Process for Reversible electrodialysis,” U.S. Pat. No. 3,282,834, which teaches a chemical process specifically designed to avoid electrolytic hydrogen production when passing electrical current through water. Citing this patent, LeFevour and Barish in “Method and apparatus for generating power utilizing reverse electrodialysis” teach in U.S. Pat. No. 4,171,409 that “[t]he concentrated and dilute ionic solutions are regenerated by thermal separation from the solutions exiting from the unit and are recycled back through the unit.” Solar-powered separation of more and less concentrated ionic solutions might in fact be incorporated as a way to drive the process of the current invention, whose innovations lie in areas other than the supply of ionic solutions of differing concentrations.

In the various approaches from the past, stacking of alternating selective anion-permeable and cation-permeable membranes is used to develop a higher output voltage than is feasible from a single cell. In the case of fresh water and seawater, an upper voltage limit for each pair of cells is about 40 millivolts, while significantly less voltage is available at a useful flow of electric current and after partial loss of the starting salinity differential due to ion migration. Greater salinity differences and greater voltages are possible where highly saline solution is available, for example from the Dead Sea or from solar concentration processes. It is noted that for fresh water and an ionic saline solution, the total recoverable energy from the salinity differential varies roughly as the square of the concentration of the saline solution. This is true because the electrical potential is linear with concentration difference and the number of recoverable coulombs of electrical charge-per-volume is also linear with concentration difference, giving a square-law dependence for the volts-times-coulombs energy product associated with a given water volume.

Aside from the low voltage-per-cell available from reported processes, there is also a limitation in the cumulative voltage obtainable from a large cell stack. As analyzed by Rubinstein et. al. (I. Rubinstein, J. Pretz and E. Staude, “Open circuit voltage in a reverse electrodialysis cell” March 2001, http://pubs.rsc.org/ej/CP/2001/B010030G.pdf) this voltage limitation is also understandable from relatively simple arguments. The stacked cells in a “salination battery” all share salt water input from a common source, for example, the ocean. The cells also drain into a common brine sink. Thus, for continuous source and sink flow paths, there will be stray electric currents flowing into the fluid source and sink. Inevitably as voltage is built up cumulatively over hundreds of cells operating in series, leakage currents from the cells at higher potentials will accumulate to limit the voltage output from the end cells. Series electrical connection of separate salination batteries does not solve the short-circuit problem if the separate batteries have continuous fluid connection to salty source and/or sink solutions. This voltage limitation could be overcome by further design complications, for example, by using peristaltic pumps to introduce and remove salt solutions from various sections of a battery while isolating the solutions electrically, in boluses, from the source and sink. Options like this compound an already difficult process requiring hundreds of fluid cell and membrane layers to recover even a few volts. Thus, there are engineering advantages to recovering electrical energy at low voltage and high current using a relatively small number of stacked series-operating fluid layers and membranes. On the other hand, recovery of electrical energy at low voltage presents practical problems, for example, of efficient electronic inversion from DC to transformable AC starting with low voltage and very high current. An impediment to further development of reverse electrodialysis equipment has been the lack of an improved way to utilize electric power at a low voltage.

### OBJECTS OF THE INVENTION

It is an object of the present invention to employ reverse electrodialysis of more concentrated and less concentrated ionic solutions (for example of seawater and fresh water) using a stack of alternating solutions and alternating differentially-permeable membranes, operated in conjunction with a reagent cycle in electrode cells at the ends of the alternating stack, to produce hydrogen gas. It is a further object intermittently to alter the reagent content or reagent flow in the end-cell cycle, thereby inducing electrolytic production of one or more antimicrobial chemicals (for example, sodium hydroxide and/or chlorine oxidants) that are cycled through the apparatus for anti-biofouling purposes. It is a further related object, following an anti-biofouling cycle, to recombine the antimicrobial chemicals and other chemicals produced by electrolysis into a usable solution or a non-toxic disposable solution. An example of a usable recombination solution would be a sodium sulfate reagent solution, created by combining an electrolytically produced sodium hydroxide antimicrobial solution with electrolytically co-produced acidic solution of sodium bisulfate and sulfuric acid. An example of a non-toxic disposable solution would be the end product of combining electrolytic antimicrobial chlorine oxidants, co-produced sodium hydroxide, and sulfonation compounds to neutralize the last of the chlorine oxidants. It is also an object, in the operation of the hydrogen-generating and antimicrobial chemical-generating cycles, to reverse the order of alternating ionic concentrations and thereby reverse the directions of ion flows through membranes, thereby reducing the accumulation of deposits on the membranes (for example, of crusts of calcium compounds.) Another object relating to efficiency of the reverse electrodialysis process is to design for primarily laminar fluid flows of alternating fluid types between alternating membrane types, excepting for “mixing obstacles” or aeration bubbles introduced in selected places along the flow path, in order to mix fresh solution from the regions midway between cell membranes with depleted solution close to the membrane surfaces, thereby increasing the concentration differentials operating across the membranes and causing higher ion flows. These and related objects and techniques will become clear in the Specification to follow.

### LIST OF FIGURES

FIG. 1 schematically illustrates the ion and electron flows and chemical reactions employed in a multilayer salination hydrogen battery, combining reverse electrodialysis with hydrogen-producing electrolysis.

FIG. 2 illustrates the fresh and salt water flow paths associated with the operation of the plant in FIG. 1.

FIG. 3 schematically illustrates an alternative operating mode for the system of FIG. 1 for the direct generation of chemicals to kill biofouling organisms in the system.

FIG. 4 shows the anti-biofouling chemicals of FIG. 3 being circulated throughout the apparatus, while it is temporarily isolated from the environmental fluid sources and fluid sink.

FIG. 5 shows steps of a method for hydrogen production and self-cleaning cycles in an apparatus functionally represented by the above figures.

FIG. 6a shows pair of membranes separated by spacers, viewed from the convex side of fixtures that hold the membranes at controlled spacings.

FIG. 6b shows a concave-side view of the membranes and spacers of FIG. 6a.

FIG. 6c is an expanded view from FIG. 6a, more clearly showing clamp features that induce mixing of the ionic solutions passing through.

FIG. 6d is an expanded view from FIG. 6b, emphasizing the same features as FIG. 6c but from a different viewing angle.

FIG. 6e is a further expanded view from FIG. 6c, providing sufficient resolution to show snap-together male and female clamp components and how they capture the membrane.

FIG. 7 shows a larger stack of alternating membrane types with alternating fluids introduced from opposite ends and flowing in opposite directions, this stack being built up and stabilized using clamps like those shown in FIGS. 6a through 6e.

### SUMMARY OF THE INVENTION

Wherever a river flows into the ocean, there is a tremendous dissipation of thermodynamic energy as the fresh river water mixes with salty ocean water. Expressed in terms of an equivalent hydrostatic head, the energy differential between fresh water and typical ocean water is approximately 250 meters. That is, the energy loss from mixing at sea level, in a river mouth, is equivalent to having the river water fall from a height of 250 meters. It has been demonstrated that a significant fraction of this dissipated energy can be captured and recovered as electricity using reverse electrodialysis, or RED, but previously at a prohibitive cost. There was a high capital investment in selectively-permeable membranes and associated equipment. There was a high maintenance cost to keep the membranes free of scale and biofouling. There was also a significant cost in providing relatively pure fresh and salt water for this process. Finally, the electrical output from an RED apparatus was inherently very low voltage, with practical and economic difficulties in obtaining more useful higher voltages.

The present invention combines the RED process with the electrolysis of water to produce hydrogen and oxygen directly and efficiently in an integrated hydrogen salination battery, without intermediate energy conversion steps. The apparatus is called a battery because it employs a stack of cells, consisting of alternating layers of fresh and salt water separated by selective ion-permeable membranes. It is a salination battery because it operates in the reverse direction of desalination equipment, for example, electrodialysis desalination devices. It is a hydrogen salination battery because its output power takes the form of hydrogen gas along with a separate stream of co-produced oxygen gas. Hydrogen is a highly useful energy form because it can be stored, it is transportable, and it can be combined with oxygen in a fuel cell to generate electricity on-demand, leaving only water behind. The disadvantage to increasing use of hydrogen as a clean fuel has been the pollution and inefficiency entailed in producing the hydrogen from fossil fuels or nuclear power. A hydrogen salination battery produces hydrogen from a renewable resource, fresh water, with low environmental impact. This technology has the potential to transform a river blocked by a series of hydropower dams into a free-flowing river, part of whose flow is diverted at sea level to produce more power, in more useful form, than was recovered by the series of upstream dams that this technology could replace or augment.

The operation of the hydrogen salination battery of the present invention may be periodically rearranged, by changing the reusable catalytic reagents, to produce antimicrobial chemicals used in an anti-biofouling cleaning cycle. A single such battery can be switched from a hydrogen-producing mode of operation to a self-cleaning cycle, and then back to hydrogen production. Alternatively, one or more salination batteries can be dedicated to antimicrobial chemical production, to be used in the cleaning of hydrogen-producing batteries. For example, concentrated sodium hydroxide solution, NaOH, can be produced in end cells and then circulated through the central membrane stack to kill bacteria and other microbes, thereby inhibiting biofouling of the membranes. It is similarly possible to produce strongly oxidizing chlorine compounds such as hypochlorous acid and sodium hypochlorite in end cells, with these chlorine oxidizers potentially being used against biofouling. It is cautioned, however, that some ion-selective membranes are damaged by strong chlorine oxidants, whereas there are ion-selective membranes that are known to withstand concentrated NaOH solutions. Following a cleaning cycle, the electrolytically-separated anti-biofouling chemicals are re-mixed, along with possible compensatory reagents (for example, sulfonation compounds for dechlorination), allowing the antimicrobial chemicals to recombine with other components to produce non-toxic compounds (for example.) The remaining effluent after chlorine cleaning and recombination of fluids may be a harmless dilute salt brine with small quantities of organics and sulfates. The end product after sodium hydroxide cleaning and recombination of fluids may be an acidic solution of largely ionized sulfate, sodium, and hydrogen, finding subsequent use as an end-cell reagent to promote hydrogen production while avoiding chlorine co-production.

To obtain a self-sustaining process, battery operation in this invention includes a periodic polarity reversal, where the fresh and salt water inputs are reversed, causing a reversal of ion flows across membranes and a reversal of which battery end-electrode produces hydrogen and which produces oxygen. The reversal of ion migration reverses the buildup of crusts on membranes, particularly of calcium compounds. This reversal operation is similar to the process known as electrodialysis reversal, as used in desalination equipment. While both processes achieve the same end of minimizing crust buildup, the method of achieving this end involves a redirection of salt and fresh fluid flows rather than reversal of an externally applied electrode voltage.

The final feature of this invention concerns efficient use of the selective ion-permeable membranes, as promoted by controlled mixing of fluid within layers, either by mixing-inducing features introduced in the fluid passageways, or by aeration. As will be described in more detail below, half the membranes selectively pass positive ions, mostly sodium with lesser amounts of calcium and magnesium, while blocking negative ions, primarily chloride. The other half of the membranes selectively pass the negative ions while blocking the positive ions. Ionic salt concentration gradients across these membranes propel selective migration of the positive or negative ion type, producing voltage and current. This ion migration rate quickly becomes self-limiting as the local ion concentrations at and near the membrane surfaces are altered, with two effects:
1) a reduced cross-membrane concentration differential, as migrated ions accumulate locally; and,
2) creation of localized electrical potential differences that inhibit further ion migration.

More rapid ion migration can be promoted by stirring or turbulent mixing of the fluids within the separated layers, bringing fresh fluid to the membrane surface, restoring the concentration differentials at the membranes, and mixing positive and negative ions, thus reducing the migration-inhibiting localized electric fields. The nature of the electrodialysis process, whether operated in a forward energy-consuming direction or a reversed energy-producing direction, is that salty and fresh waters flow slowly in thin layers between membranes. The fluid flow regime thus tends to be laminar, meaning that the flowing layers stratify and concentration gradients arise. If the fluid flows through fast enough to induce turbulent flow and mixing within layers, then the fluid generally does not remain in membrane contact long enough for sufficient ion transfer—unless the fluid is forced to recirculate through many passes. Forced recirculation of the fluids can bring about turbulence, but the pumping power budget rises rapidly. The present invention addresses the problem of fluid layer stratification with controlled low-energy mixing, by either or both of two approaches:
1) aeration bubbles rise through the membrane spaces; or,
2) flow obstructions produce fluid turnover and destratification.

As illustrated and described below in a preferred embodiment, membrane spacers in this invention are designed to induce a controlled amount of fluid mixing and destratification. This design may have fluids pass through just once, without recirculation. The membranes are spaced wide enough to permit fluid flow without excessive head loss due to flow resistance. This smooth fluid flow is interrupted where fluids pass over membrane spacers than disturb the flow just enough for needed mixing. Sustained turbulence is not needed to reduce stratification to acceptable levels, and the eddy-inducing membrane spacer approach achieves the needed compromise between fluid mixing and low pumping power.

Chemical Cycles

Describing the system in greater detail, the hydrogen salination battery uses a stack of ion-selective membranes, alternating between cation-permeable membranes and anion-permeable membranes, those membranes separating alternating layers of ionic solution having relatively high and relatively low ion concentrations—so-called “salt-solution” and “fresh water” layers (recognizing that the “fresh water” source might be brackish and that the concentration difference between the sources is what matters.) The stack of alternating membrane types and alternating solution types forms a voltage-generating battery, capped by a pair of end electrodes. These end electrodes may be short-circuited together for free current flow and maximum production of hydrogen. Electrical energy may optionally be drawn off concurrent with the hydrogen production (although this option requires extra equipment.)

It is possible, optionally, to supplement the “passive” chemically-derived electrical potential with an externally applied electrical potential, for example when heavy rains or unusual ocean currents reduce the ion concentration difference and a small supplemental energy boost might pay back with a great increase in hydrogen production. Given the added cost of equipment for such a boost, or for drawing off electrical energy, a preferred embodiment is described here with no supplemental energy boost and no electrical energy recovery, relying entirely on “passive” electric currents from ion concentration differences to produce hydrogen.

The practical process uses periodic chemical anti-biofouling cycles and periodic polarity reversals to avoid crust buildup. The anti-biofouling chemicals may optionally be produced by electrolysis, employing the same reverse electrodialysis and end-electrode components that are used, in another part of the operating cycle, to produce hydrogen.

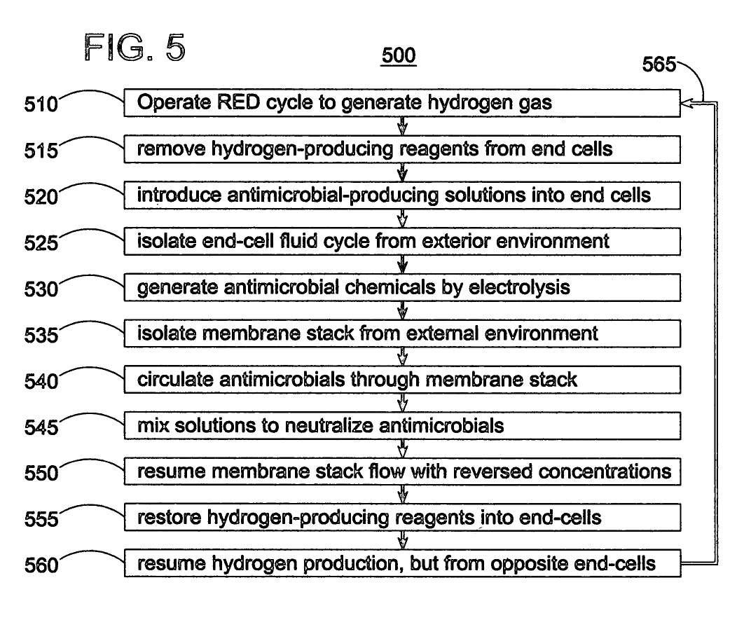

The overall process, including production steps and maintenance steps, is summarized by a cycle of eleven steps, illustrated in FIG. 5 in method diagram 500 and summarized here, with reference to the number labels of FIG. 5:
1. (at 510) A reverse electrodialysis (RED) cycle is used to generate a DC electric current in a stack of alternating solutions of low and high ionic concentrations, separated by alternating cation-permeable and anion-permeable membranes. A separate reagent solution is circulated between the stack and the short-circuited end electrodes to promote the release of hydrogen gas at the end toward which positive ions migrate through the stack, commonly with oxygen gas being produced at the opposite end from the hydrogen-producing electrode.
2. (at 515) In preparation for an antimicrobial cleaning cycle, the hydrogen-producing reagents may need to be removed from the end electrode cells (depending on the nature of the cleaning cycle.)
3. (at 520) Solutions are introduced into the end electrode cells that will generate antimicrobial chemicals by electrolysis. These solutions may consist, for example, of common seawater, whose chloride ions are transformed electrochemically into a mixture of hypochlorous acid and sodium hypochlorite, and whose sodium ions produce caustic sodium hydroxide solution. Alternatively, it may be desired to continue using reagents that prevent the formation of chlorine oxidants while altering flow and pH conditions to induce production of sodium hydroxide as a cleaning solution.
4. (at 525) The solutions in the end electrode cells are isolated from the external environment prior to production of antimicrobial chemicals.
5. (at 530) The RED cycle drives the electrolytic production of antimicrobial chemicals, for example, production of chlorine from chloride ions, where the dissolved chlorine goes on to produce chemicals such as hypochlorous acid and sodium hypochlorite; or alternatively, production of sodium hydroxide in sufficient concentration to kill microbes.
6. (at 535) The stack of alternating membranes and cells between the end electrode cells is isolated from the external environment. This sixth step may optionally precede the previous step of antimicrobial chemical production, provided that there is enough stored chemical concentration-differential energy in the stack to produce the needed amounts of antimicrobials.
7. (at 540) Optionally in preparation for the antimicrobial circulation, the solutions in cell stack may be flushed with clean fresh water to maximize effectiveness of the antimicrobial compound (for example, to minimize the chlorine demand, or to minimize neutral-salt pH buffering of sodium hydroxide.) With or without the preliminary flushing step, the antimicrobials produced in the end cells are circulated past all the membranes in an RED stack.
8. (at 545) Antimicrobial and other solutions are mixed to neutralize the toxicity of all the solutions. For example, if sodium chloride is of primary use in antimicrobial generation, then chlorine is produced electrolytically, combining with water to produce hydrochloric acid and hypochlorous acid. On the opposite electrode, electrolysis produces sodium hydroxide with the liberation of hydrogen. Some of the sodium hydroxide is typically mixed with the chlorine chemicals to reduce or neutralize the acidity from the hydrochloric acid, leaving hypochlorous acid and increasing chlorine solubility in the solution (to prevent out-gassing of chlorine.) Some of the hypochlorous acid exchanges its hydrogen for sodium, becoming sodium hypochlorite, which like the hypochlorous acid is a good oxidizer and a powerful antimicrobial agent. Following a cleansing cycle (previous step), the chlorine solution is dechlorinated by adding appropriate reagents (for example, sulfonation compounds) and pH-adjusted by re-introduction of sodium hydroxide solution produced along with the chlorine compounds. Alternatively, sodium hydroxide may be used as the primary cleaning agent, while reagents may be introduced to inhibit the production of chlorine oxidants. These are but examples of electrolytic production of cleansing and antimicrobial chemicals. The particular choice of chemicals will depend on effectiveness, time needed to produce effective amounts of antimicrobial solution, and particularly on compatibility of the antimicrobial solution with the chosen membrane types.
9. (at 550) Following an antimicrobial cleaning cycle, RED stack flow is resumed, optionally with a reversal of the alternating solutions, so that cells previously containing relatively dilute electrolyte solution now contain concentrated electrolyte and vice versa. This direction reversal, described as following a cleaning cycle, may actually take place at any time during plant operation, the purpose being to roughly equalize the cumulative ion migration flows across membranes and minimize cumulative buildup of scale on the membranes. The solution reversal will be accompanied by a reversal of electrode current flow and a switch of the electrode end from which hydrogen is liberated.
10. (at 555) Hydrogen-producing reagents are introduced or re-introduced into the electrode end cells. The reagents may, for example, consist of a mixture of sodium sulfate, sodium bisulfate, and sulfuric acid, where the hydrogens in the sodium bisulfate and sulfuric acid support hydrogen production while hydrogen ion concentration is replenished by the electrolysis of water to liberate gaseous oxygen opposite the hydrogen-producing electrode.
11. (at 560) Hydrogen production is resumed, with the reversal of which end cell is producing hydrogen if there has been an electrodialysis reversal. This step becomes the starting step (510) of the above sequence and of the FIG. 5 diagram, from which continues a new period of hydrogen production followed by antimicrobial and anti-scale-buildup maintenance cycles.

The temporal sequence of the above steps may be altered from the order just given. The same stack of reverse electrodialysis cells used for hydrogen production may be used to generate anti-biofouling chemicals. In a preferred embodiment to be described below, the same concentration-differential energy is used, in the same cell stack but at separate times and under different operating conditions, for hydrogen production and for anti-biofouling chemical production. Alternatively, completely different stacks may also be used separately for each of the two processes. Thus in a hydrogen generating installation with multiple cell stacks, some stacks may be dedicated to the production of anti-biofouling chemicals while other stacks are dedicated to hydrogen production. In that case, the stacks with different specialized functions may be differently optimized in construction and/or materials.

Mechanical Mixing for Improved Ion Exchange

Another aspect of the invention is an efficient design for ion migration across the selectively permeable membranes. To extract a significant fraction of the mixing energy from input streams of relatively fresh and relatively saline solutions, those solutions must be layered in very close physical proximity, preferably in fluid layers from a few millimeters to a fraction of a millimeter in thickness, and must remain in such proximity for a significant dwell time: from many seconds to a few minutes. With thin fluid layers moving at low flow rates, the flow tends to be laminar. Under laminar conditions, the concentrations in the more saline solutions tend to become depleted right next to the sandwiching membranes while the concentrations in the less saline solutions become more concentrated right next to the membrane. In other words, the concentration differential across the membrane is reduced by concentration gradients within the fluid layers.

The flow of ions in stratified solutions is further inhibited since the stratified ion concentrations create electrical potential gradients that inhibit ion passage across the membrane. Consider, for example, a selective cation-permeable membrane separating a relatively concentrated sodium chloride solution on the left from a more dilute solution on the right. Starting with uniformly mixed solutions on the two sides, sodium ions will migrate from left to right across the cation-permeable membrane to the dilute side while chloride ions will be blocked. Soon there will be more chloride than sodium ions just to the left of the membrane and more sodium than chloride ions just to the right of the membrane. In the absence of additional voltage gradients arising from the larger system of the salination battery and end electrodes, these charge-imbalanced concentrations will generate an electric field across the membrane, positive-to-negative from right to left, from the positive excess of sodium ions on the right to the negative excess of chloride ions on the left. This gradient will repel further positive ion migration from left to right. Consider, however, the right side of the dilute right-hand cell. That side of the cell is bounded by a anion-permeable membrane, which will have an excess of chloride ions near its left surface, as these ions will have migrated from the greater concentration to the right of that right-hand membrane. The potential gradient across this and other anion-permeable membranes in the battery stack will again be positive-to-negative from right to left, in this case inhibiting further negative chloride ion migration from right to left. In other words, in a stack with alternating membrane types and alternating high and low concentrations of ionic salts, all the membranes of both types will tend to experience localized electric fields in the same direction, in one case inhibiting positive ion migration from left to right, in the other case inhibiting negative ion migration from right to left.

Accompanying these membrane potential gradients are opposite gradients across the fluid-filled cells, positive-to-negative from left to right, promoting ion migration across the fluid layers. In a practical situation, however, the membrane thicknesses may be less than 0.1 millimeters (or about 0.004 inches) while the fluid layer thicknesses will be many times greater. Although ions of the selected permeability type are likely to be less mobile within membrane materials than in solution, the membranes are likely to be so much thinner than the fluid layers that ion mobility within the stratified fluid layers becomes the limiting factor for current flow and hydrogen production. Mechanical mixing of the fluid can greatly augment electric-field-driven ion migration across the fluid layers, sweeping away stratified charge layers and mixing ions of opposite charges. Thus, with mechanical mixing the selective membranes are used to maximum effect. The efficiency of the entire process and the hydrogen-generating productivity of the relatively costly selective membranes hinge on an appropriate level of mechanical mixing of fluids, enough to substantially neutralize migration-inhibiting ion buildup but not enough to incur an excessive power budget for forced fluid mixing.

### DESCRIPTION OF A PREFERRED EMBODIMENT

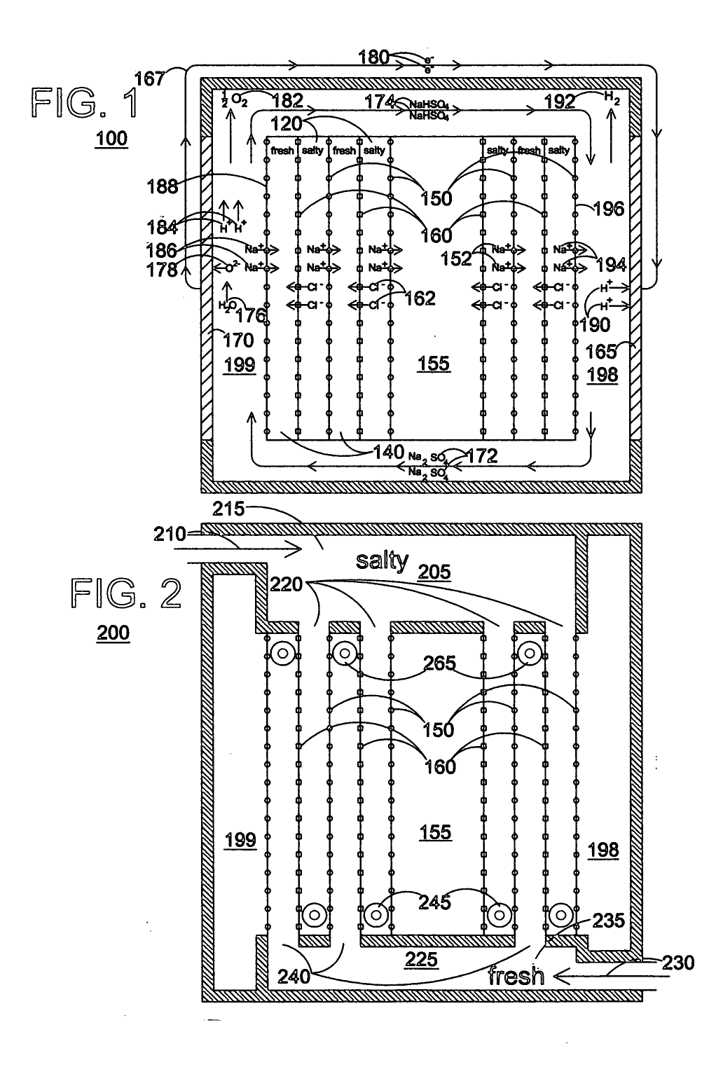

Hydrogen Generation by Merging Reverse Electrodialysis with Electrolysis FIGS. 1 and 2 provide schematic representations of two views of a device for hydrogen production combining electrolysis with reverse electrodialysis, or RED. They also indicate the most significant ion migrations and chemical reactions. For comparison, the Netherlands project reported by Post (see Background of the Invention) achieved electric currents utilizing a redox chemistry involving iron ions transitioning back and forth between Ferrous (Fe²⁺) and Ferric (Fe³⁺) forms. This chemistry minimized electrode potentials and thereby maximized electrical efficiency. Electrolyzing salt water without special reagents would produce hydrogen, but with the byproducts of chlorine and sodium hydroxide. The present invention might use this or a similar chemistry selectively for antimicrobial cleaning, though there are compatibility problems with chlorine and at least some ion-selective membranes. For generation of hydrogen and oxygen, however, a different end-cell chemistry is described as follows.

FIG. 1 and FIG. 2 together provide a schematic representation of the physical hydrogen salination battery structure from two views. If FIG. 1 is considered to be plan view 100, then FIG. 2 becomes an end view 200, rotating the battery 90 degrees about a horizontal axis. This end view 200 shows salty water 205 introduced from above at 210 into salt water inlet manifold area 215, then flowing down the diagram through alternate membrane-bounded spaces 220. Similarly, fresh water 225 is introduced from below at 230 into fresh water inlet manifold area 235 and then flows up the diagram through the remaining membrane spaces 240. Spaces corresponding to 220 and 240 are seen in FIG. 1, respectively at 120 and 140 and similar spaces. Both salty and fresh fluid flows terminate in fluid sinks, represented schematically as circles with large dots in the middle, with originally salty fluid from 220 flowing into sinks 245 and originally fresh fluid from 240 flowing into sinks 265. The fluid paths entering both sinks 245 and sinks 265 join together into a common brine effluent stream (not shown). During normal operation, the salty water 205 loses solute ions and becomes more dilute by the time it enters sinks 245, while the fresh water 225 picks up most of these ions and becomes a dilute saline solution by the time it enters sinks 265. Continuing fluid flows normally maintain concentration gradients that drive the coupled electrolysis and reverse electrodialysis process represented in FIG. 1, which is now described. In the reagent circuit, which is isolated from the fresh-saline circuit, the end cell areas 198 and 199 are seen in the views of both FIG. 1 and FIG. 2.

The driving electrical potential for hydrogen production arises from the alternating layers of fresh (140) and salty (120) water captured between alternating semipermeable membranes. The circles 150 on the vertical membrane lines, seen in both FIGS. 1 and 2, symbolize pores that selectively pass sodium ions (Na⁺, 152), while the squares 160 on the alternate membrane lines symbolize pores that selectively pass chloride ions (Cl⁻, 162). The numbers 150 and 160 will be taken to identify both the ion-selective pores and the corresponding selective membranes themselves. The sodium and chloride ions are drawn schematically in pairs, providing symbolic correspondence to stoichiometry equations involving pairs of ions, as discussed below. Other ion types will typically be present in lower concentrations. Membranes 150 that selectively pass positive sodium ions commonly pass other positive ion types as well, while blocking negative ions. Similarly membranes 160 that selectively pass negative chloride ions will pass other negative ion types while blocking positive ions. Ions other than sodium and chloride are ignored in the following discussion, even though these ions contribute to net electrical conduction and may contribute to hydrogen production, depending on the particular ions and their chemistry, including their electro-negative or electro-positive potentials.

The numbers 155, seen in central spaces between membranes in both FIGS. 1 and 2, indicate many repetitions of alternating fresh and salty fluid layers and of selective membranes similar to the layers shown and labeled. The concentration difference across each membrane drives the allowed ions across while the oppositely charged ions are blocked. This selective transport of ions, positive to the right and negative to the left, builds a cumulative voltage across the layers of the salination battery, which appears as a voltage difference between the reagent solutions in the right end cell (198) and the left end cell (199), contacting electrodes 165 and 170, which are interconnected and effectively short-circuited together by wire 167. These electrodes are shown with light cross-hatch, while non-conducting containment walls are shown in alternating light and dark line hatching. The typically low resistance of wire 167 gives rise to a slight positive voltage on electrode 165, relative to a slight negative voltage on electrode 170. This small voltage differential can be measured to quantify the current flow in 167 and thereby monitor the rate of ion migration and hydrogen production. The voltage difference generated across a pair of fresh-water cells sandwiching a saltwater cell is determined by the concentration difference between the salt and fresh water layers, by the degree of ionization, and by the selectivity of the membrane. Since the end electrodes are shorted to nearly equal potentials, most of the cumulative voltage differences from the cell layers contribute to hydrogen production and ion migration.

For a rough evaluation of performance of this system, it is estimated that the membrane ion selectivity is close to 100%. It is further estimated that the van't Hoff coefficient “i”, indicating the relative degree of ionization of NaCl, at a typical concentration (after some process loss of NaCl as ions cross into fresh water) of about 0.5 molar, is about i=1.83 (where i=2.00 would represent 100% statistical splitting of every NaCl molecule into 2.00 ions. The value shown is interpolated from a table at: http://www.wsu.edu:8080/˜genchem/chem106/notes/slides14.htm.) For preliminary estimates it is further assumed that the original seawater salinity is a “typical” value (as widely reported, e.g., by sellers of desalination equipment for boats) of 35 gm. NaCl per liter of water. Calculations are based on 2 liters of seawater being used for every liter of fresh water, and such that the salinity of the fresh water rises to a discharge load of 33.33% of the original seawater salinity while twice that much seawater is discharged with a relative dilution of 16.67%, i.e. at 83.33% of its original salinity. It is further assumed that the selective membranes pass the chosen ion type much more readily than they pass water, so that migration of fresh water across membranes into seawater is insignificant compared to the exchange of ions. With these assumptions, the average voltage differential per cell pair (from one fresh water cell to the next, across a sandwiched salt water cell) is 31 millivolts. It is further assumed that the central stack of water layers and membranes consists of 73 saltwater layers and 73 fresh water layers, with 74 sodium-permeable separator membranes and 73 chloride-permeable membranes. This yields an open-circuit potential, in the outermost layers, of approximately 2.25 volts. The energy recovered from concentration differentials to provide this differential, with the cumulative ion migration quantities indicated above, is about 600,000 joules per cubic meter of water, equivalent to a hydrostatic head of 600,000 Pascals or 61.2 meters=200 ft. of fresh water. Some of this energy produces hydrogen while some of it keeps the hydrolysis moving at a reasonable rate, as is now explained.

The stack voltage drives production of gaseous hydrogen and gaseous oxygen requiring approximately 1.5 volts (above a theoretical energy content of 1.23 volts, allowing for energy to drive other parts of the reaction. See: http://www.geocities.com/mj_{—}17870/test.html, which gives an example where 1.47 volts is required, before resistive losses, to recover the 1.23 volts of energy in the liberated hydrogen and oxygen.) The remaining 0.75 volts is left to keep the ions moving—their migration would be stopped if 100% of the available voltage was required to provide the electrolysis potential. In terms of energy in delivered hydrogen gas, then, the recovery fraction is the voltage ratio 1.23/2.25=54.7%. That gives 328,000 joules of hydrogen energy per cubic meter of fresh water, or an effective 100%-utilized head height of 33.4 meters, 110 feet. For comparison, a conventional hydropower dam operating electrolytic cells would have to pump high-amperage DC current at about 1.5 volts, overcoming similar losses, or perhaps lower, because it would employ more concentrated electrolytes than seawater and brine. Assume, for argument, that a small hydropower installation has various losses:
hydro-to-mechanical efficiency of 80%;
mechanical-to-low-voltage-DC efficiency of 80%;
electrolysis efficiency of 80%, to overcome resistance and maintain a current density at 1.5 volts electrolysis potential; and
1.23/1.5=82% recovery from the electrolytic potential to the final hydrogen energy.

Then the comparison head height for hydrogen production would be 79.6 meters=260 feet. That is to say, if river water emptying into the ocean were somehow dammed up, passed through a turbine, converted to low-voltage DC electricity, and used to drive a reasonably efficient electrolytic cell at a moderate rate, then the required head height to compare with sea-level salination conversion would be on the order of 80 meters or 260 feet.

These are approximate values and do not account for other losses in the salination-hydrogen process. Some energy will be required to keep water moving past the large membrane areas, with some turbulence or aeration mixing to bring ions close to the membrane surface and avoid localized ion depletion. Some energy and downtime will be required for water filtration and antifouling treatment, as is described below. On the other hand, the “conventional” comparison benchmark might also be overly optimistic. Neither scenario includes the energy needed to compress the hydrogen gas, or transport it, nor do the scenarios consider the energy loss in utilizing the hydrogen.

Hydrogen Electrode Chemistry

As illustrated in FIG. 1, the preferred system embodiment employs a recirculating reagent mixture of a neutral salt, sodium sulfate (Na₂SO₄, 172) and acidic sodium bisulfate (NaHSO₄, 174). These strongly ionizing reagents will be present almost entirely as ions floating in solution: hydrogen (H⁺), sodium (Na⁺), and sulfate (SO₄²⁻).

As indicated on the left of FIG. 1, a water molecule (H₂O, 176) dissociates, with a doubly charged oxygen (O²⁻, 178) giving up two electrons (180, top) to become half a molecule of oxygen gas (½ O₂, 182, exiting from the top left) and leaving behind two acidic hydrogen ions (2H⁺, 184). These hydrogen ions replace two sodium ions (2Na⁺, 186) coming from the two recirculating sodium sulfate molecules (2Na₂SO₄, 172) in the solution rising from below into the oxygen-producing end cell 199. The two sodium ions (2Na⁺, 186) cross the cation-selective permeable membrane 188 to the right, the first of the group of similar sodium-permeable membranes 150 in the stack, while the two hydrogen ions (184) move upward, becoming part of the two sodium bisulfate molecules (2NaHSO₄, 174) seen moving to the right across the top of the diagram. In fact, these molecules will be mostly dissociated into Na⁺, H⁺, and SO₄²⁻ ions, and a few sulfuric acid (H₂SO₄) molecules will appear and disappear in the dynamic mixture.

The two electrons from the oxygen are also seen at the top of the diagram (180), traveling from the oxygen-liberating electrode 170 on the left through wire 167 to the hydrogen-liberating electrode 165 on the right. The two hydrogen ions 190 from the two sodium bisulfate molecules travel to the right-hand electrode at 165, taking on the two electrons 180 from the electrical conductor above and becoming a neutral hydrogen gas molecule (H₂, 192, exiting from the top.) Two sodium ions 194 come in across membrane 196 (which is the right-hand-most member of the group of sodium-permeable membranes 150), coming into end cell 198 from the salt solution to the left of membrane 196 to replace the two hydrogen ions 190, providing the extra sodium for the two sodium sulfate molecules 172 seen circulating to the left across the bottom of the diagram, from end cell 198 to end cell 199.

Antifouling Chemistry

Outside the lab, real seawater and real river water will inevitably carry nutrients and bacteria, so there will be biofouling on the membranes. There is also an issue of fouling by mineral scale formation. Other brine resources may provide cleaner “fuel” for the process, for example if a solar evaporation pond (or a natural body like the Dead Sea) is used to re-concentrate effluent brine, providing a renewable supply of saltwater far from a coastline. Some salt and fresh water resources will be cleaner than others, but most resources will include silt, bacteria and nutrients, thus calling for high levels of filtration followed by antifouling measures. An approach to chemical cleaning with antibacterial action is now described.

The first level of antifouling defense is settling and mechanical filtration. A membrane process will need much cleaner water than is required to run a hydro turbine. Observe, however, that the bulk of liquid water involved does not pass through the membranes. Instead, while there is some diffusion of water across the membranes, mostly it is the ions in the water that pass through the membranes. Consider, for example a seawater solution containing 35 gm/liter of salts, mostly sodium chloride. In the energy calculation given above, it was assumed that one-third of the salt ions passed through membranes into fresh water, representing just under 12 grams per liter. In other words, the mass of ions passing through membranes is only on the order of 1% of the mass of water moving past the membranes. The situation is therefore very different from previous experimental approaches using mechanical osmotic pressure for power generation, where a substantial fraction of the fluids being used actually had to pass through a membrane, leaving filtered-out substances deposited on the membrane. In mechanical osmotic energy recovery, the osmotic membrane must be supported against the recovered head of pressure, whereas reverse electrodialysis membranes operate at nearly zero pressure, being supported mechanically only enough to assure stability and maintain approximate cell spacing.

The second line of antifouling defense is chemical. The technologies used for wastewater treatment and protection of municipal water supply are potentially applicable, with the constraint that antimicrobial chemicals used in municipal water treatment might be damaging to one or more of the ion-selective membranes being employed. Thus, one potential cleaning method consists of flushing the system with clean fresh water, chlorinating the water, waiting for a microbial kill, dechlorinating, and flushing the dechlorinated water into the effluent stream as hydrogen production resumes. Recognizing that some ion-selective membranes are damaged by oxidizing chlorine compounds, however, the alternative antimicrobial approach described here for a preferred embodiment will rely on caustic sodium hydroxide. In the preferred embodiment of the present invention, the antimicrobial chemical is produced electrolytically by the same RED equipment used to produce hydrogen.

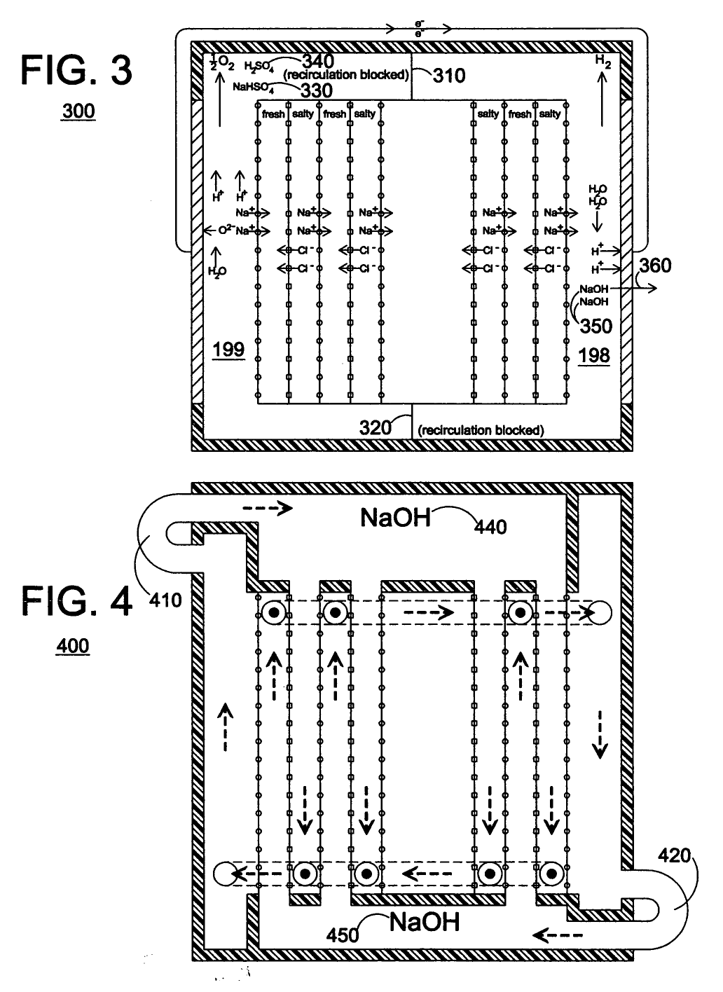

Relatively high concentrations of caustic sodium hydroxide, NaOH, are produced for antimicrobial cleansing by first shutting off the normal recirculation cycle of sodium sulfate (172) and sodium bisulfate (174), as indicated in FIG. 3 by circulation barriers 310 and 320 across the paths previously indicated by 174 and 172 of FIG. 1. The sodium sulfate reagent is flushed out of the right-hand hydrogen-producing region 198 between membrane 196 and electrode 165, replacing that solution with fresh water. As shown on the right of FIG. 3, in the absence of the sulfate solution, sodium hydroxide (NaOH, 350) is then co-produced with the hydrogen from that electrode. In the left-hand region 199 between membrane 188 and electrode 170 (of FIG. 1), in the absence of sodium sulfate (172 of FIG. 1) entering the electrode region there is a buildup of acidity as hydrogen ions accumulate. This is indicated by the presence of both sodium bisulfate (NaHSO₄, 330) and sulfuric acid (H₂SO₄, 340) in FIG. 3, whereas FIG. 1 indicated no sulfuric acid and only sodium bisulfate (174) recirculating from the left-hand electrode region. As explained for FIG. 1, the sodium bisulfate and sulfuric acid in FIG. 3 are present mostly as ions of sodium, hydrogen, and sulfate. To prevent excessive acidity on the left of FIG. 3, the solution on the left may be mixed with solution from a larger sodium sulfate reservoir, thus diluting the acid.

The chemical steps for sodium hydroxide production are described more specifically as follows. FIG. 1 shows two sodium ions (194) entering the right end cell 198. The same two sodium ions are seen in FIG. 3. These two sodium ions are reduced at the right hand electrode to metallic sodium:
2Na⁺+2e→2Na 1]

This sodium immediately reacts with water, combining with the hydroxyl group to liberate a molecule of hydrogen gas:
2Na+2H₂O→2NaOH+H₂ 2]

FIG. 3 ignores the almost hypothetical brief appearance of metallic sodium and simply represents the end result of the following two sequential reactions:
2Na⁺+2H₂O→2NaOH+2H⁺ 3]
2H⁺+2e⁻→H₂ 4]

By either description, two sodium ions plus two water molecules produce two sodium hydroxide molecules with the liberation of a molecule of hydrogen gas, while two electrons pass through the wire at the top of the diagram to balance the charge from the sodium ions.

As indicated by the arrow 360 of FIG. 3, sodium hydroxide solution is removed from the right electrode chamber and accumulated in a reservoir (not shown) for antimicrobial use. The middle spaces between membranes are then flushed with fresh water (to minimize the pH buffering effect of dissolved neutral salt) and subsequently filled with the sodium hydroxide solution, whose production was indicated at 360. As shown in FIG. 4, the circulation paths previously fed with fresh water (230, FIG. 2) and salt water (210, FIG. 2) are both converted to closed fluid circuits with the effluent paths (245 and 265, FIG. 2), resulting in closed recirculating paths (410 and 420, FIG. 4), where sodium hydroxide (440, 450) is recirculated for the duration of an antimicrobial cleansing cycle. When the cleansing cycle is done, sodium hydroxide solutions 440 and 450 are combined with the reservoir of acidic solution containing sodium bisulfate (330) and sulfuric acid (340). The reagent solution is thus restored to its original mild acidity, dominated by sodium sulfate with some sodium bisulfate in the solution. This reagent solution is removed from between the membranes in the central region of the salination battery, being flushed out by fresh water or being removed while the membranes collapse together, before salt water is re-introduced in alternate membrane spaces.

The steps described above in specific chemical terms are reiterated in general terms in the steps of FIG. 5, without reference to particular chemical species. The steps of FIG. 5 could apply equally to the introduction of sodium chloride solution in place of sodium sulfate in the end electrode cells 198 and 199. This last approach results in the production of chlorine at the electrode that normally produces oxygen, as indicated in the following chemical reaction:
2NaCl→2Na⁺+2e and +Cl₂ 5]

In not-too-acid solution and at low enough concentration, the produced chlorine remains dissolved in the water and quickly combines chemically with the water to produce hydrochloric acid and hypochlorous acid in the left end cell.
Cl₂+H₂O→HCl+HOCl 6]

The hydrochloric acid is strongly ionized and acidic. In acidic solution, the hypochlorous acid remains mostly un-ionized, in which form it passes through cell walls and kills microbes. If the pH of the solution goes beyond neutral to significantly alkaline, the hypochlorous acid becomes largely dissociated (see United Nations: “Disinfection”, WHO seminar pack for drinking-water quality, http://www.who.int/water_sanitation_health/dwq/en/S13.pdf):
HOCl [symbol] H⁺+OCl⁻ . . . with the ionized pair on the right favored by high pH 7]

Sodium hydroxide is produced simultaneously in the right end cell. Mixing part of that sodium hydroxide back into the left end cell neutralizes most or all of the hydrochloric acid, leaving most of the weakly acidic hypochlorous acid. The reduction of acidity increases chlorine solubility, helping to avoid out-gassing of chlorine. On the other hand, it is noted (in the U.N. “Disinfection” paper cited above) that the dissociated hypochlorous acid does not pass freely through cell membranes and thus is not an effective antimicrobial. Hence, the pH should not be pushed too high or antimicrobial action will be lost.

Sodium in the left end cell will combine with some of the hypochlorous acid to produce sodium hypochlorite.
HOCl+Na⁺ [symbol] NaOCl+H⁺ 8]

Both the sodium hypochlorite and the hypochlorous acid are powerful oxidizers and strong antimicrobial agents. They might potentially be used for their antimicrobial action, instead of sodium hydroxide, except for potential membrane compatibility problems. It is noted that these chlorine compounds are known to persist after the various electrolytically-separated solutions are re-mixed. As is well known in the water treatment industry, antimicrobial chlorine compounds can be neutralized by a process called sulfonation, which would probably be required in a chlorine cleansing scenario for the present invention.

In earlier conceptions of this invention, chlorine compounds were to be used for antimicrobial membrane cleaning. Further study revealed a probable compatibility problem with ion-selective membranes and the chlorine oxidants. Thus, the chlorine chemistry described here is presented as a possible alternative cleansing cycle, contingent on whether compatible ion-selective membranes are found or developed. The preferred embodiment described here avoids chlorine production by keeping chloride ions out of end cell 199 and maintaining sulfate solutions in that cell.

The steps of FIG. 5 were already described above. Note at step 550 that an advantageous procedure would end each antimicrobial and cleansing cycle with a reversal of the alternation of fresh-water and salt-water cells, resulting in a polarity reversal of the entire stack. Hydrogen would then be produced on the left of the diagrammatic counterpart of FIG. 1, and oxygen on the right, with an accompanying reversal in the direction of electric current through 180. Periodic polarity reversals of this sort are expected to reduce membrane scale buildup and prolong good membrane performance.

Ion Mixing

The advantages of mechanical mixing of battery cell solutions were discussed above.

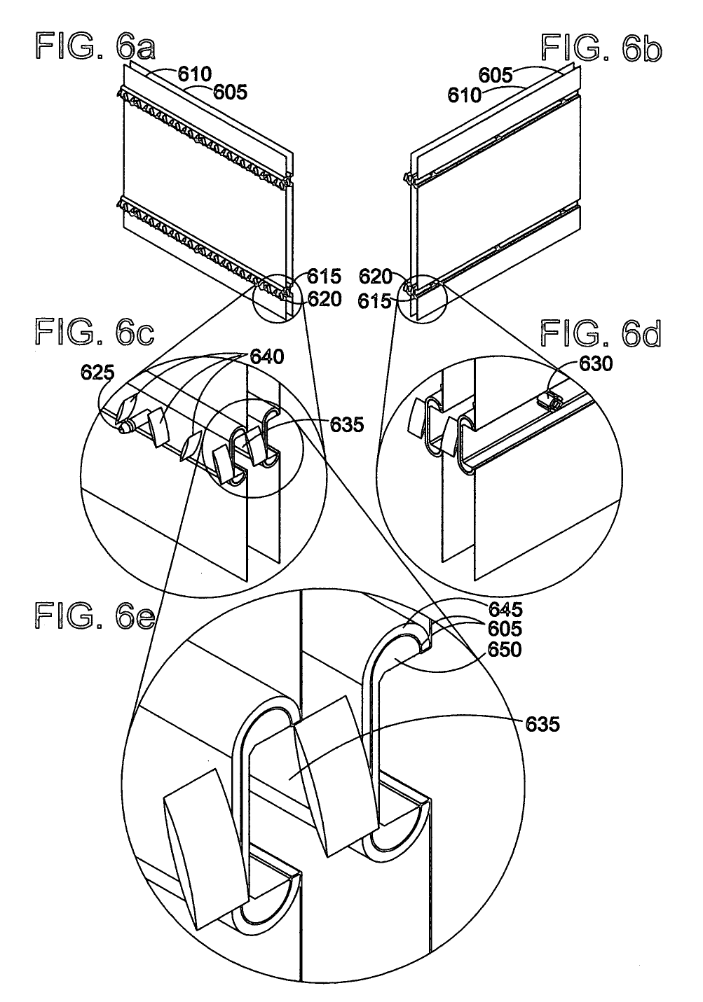

FIGS. 6a through 6e illustrate structural means for mechanical mixing by introducing eddy-inducing features into the flow path. FIGS. 6a and 6b show two views of a pair of selective membranes, 605 and 610, held by snap-together clamps 615 and 620. FIGS. 6c and 6d provide magnified views from 6a and 6b, showing clamp features intended to introduce fluid turnover. These features include the bump of a clamp's convex surface running parallel to the cavity of the clamp's concave surface, the resulting overall “jog” in the fluid path being indicated at 635 in FIGS. 6c and 6e. Coming out of the clamps, fins 640 (FIG. 6c) are angled with alternating slopes to squeeze and spread the fluid flow in alternating regions, thus inducing turnover and mixing. The nominal flow direction in these diagrams is vertical, causing fluid to pass periodically over flat spans and then through clamp mixing regions.

FIG. 6e is a further magnification from 6c, allowing one to see that clamp 615 consists of a C-shaped top clamp piece 645 and a smaller bottom insert 650, which snaps into top piece 645 to capture and hold membrane 605 along a strip of the membrane width. To maintain the spacing between the clamp pairs and the membranes they support, a male support post 625 and similar posts extend from the convex clamp piece, while a female snap-in socket to receive posts like 625 is seen at 630.

To reiterate the important points about fluid mixing, the typical flow regime between these selective membranes is laminar. The goal is not to achieve global fluid turbulence, but to produce local eddies at periodic trip points, bringing fluid from middle regions close to ion exchange surfaces. The membrane clamps cause fluid flow in either direction across the clamp to do an abrupt jog, into the cavity of the snap-in piece, then back out into the flow channel. The flow cross-section is cut roughly in half both entering and exiting the clamp cavity. To further perturb the fluid flow, septa extending out of the top of the male clamp components have alternating slopes, squeezing certain fluid paths while pushing other paths to expand—similar vortex-inducing fences are found on airplane wings to generate small vortices that bring fresh moving air down to the wing surface and help maintain large-scale flow attachment.

An alternative mixing approach is aeration. To effectively mix fluid all the way down to a membrane surface, one ideally wants bubbles slightly larger in spherical diameter than the spacing between membranes, so that each bubble scrubs the surfaces that confine it while it rises.

With either eddy-producing flow obstacles or bubbles, the design goal is to promote sufficient mixing that net ion movement is limited primarily by the membranes, rather than by stratification of the fluid between the membranes. There is a price to be paid in power consumption and equipment complexity for increasing amounts of mechanical mixing. Appropriate compromises between these competing requirements will be found for specific system designs.

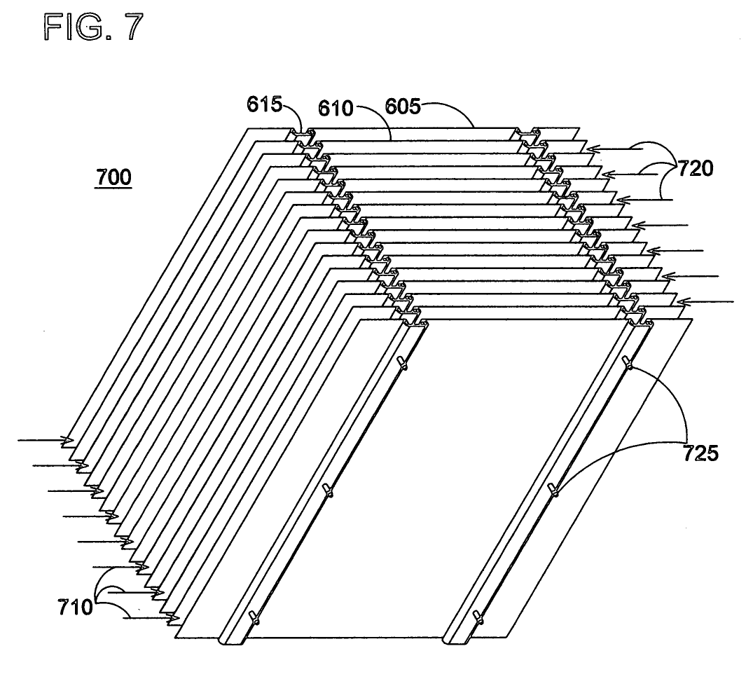

Finally, FIG. 7 shows a deeper membrane and spacer stack, made of components similar to the two-membrane stack of FIGS. 6a and 6b and the magnified views that follow. Membranes 605 and 610 and clamp 615 of FIG. 6a are seen repeated in FIG. 7, but from a different viewing angle and with many additional layers continuing the stack beyond the anion-cation pair of layers 605 and 610. The clamps pictured in FIG. 7 lack the eddy-inducing “fence” of components like 640, having only the abrupt flow constrictions and expansions with offset jogs of the earlier figures. These clamps retain snap-together features like male feature 625, viewed at 725 of FIG. 7, and also like female feature 630, with the similar features being hidden in FIG. 7. Fluid counter-flows are indicated by arrows pointing into alternating spaces between membranes on the lower left at 710, and between the remaining alternating spaces on the upper right at 720. One of those sets of flows, for example 710, can be the fresh water supply while the other set of flow arrows, for example 720, can be the salt water supply.

Given these descriptions, one is left with the challenging but manageable engineering task of designing manifolds to channel the opposing fluid flows into the alternating membrane spaces and otherwise realize, in three dimensions, the functional aspects represented schematically in FIGS. 1, 2, 3, and 4. One must further provide gates for opening and closing different flow paths, creating the controlled flow patterns described functionally above. These are manageable engineering tasks. Approaches to performance optimization have been described, along with approximate figures for certain aspects of operation. There are handbooks full of formulas for ion mobilities, for diffusion rates, and for mass transfer across fluid boundary layers under various conditions of Reynolds numbers and turbulence inducement. Widely quoted convective-conductive heat transfer formulas can be used to estimate convective-diffusive mass transfer rates governed by similar equations. The guidelines have been set down. The basic chemistry and physical chemistry are understood. Appropriate ion-selective membranes have been developed for electrodialysis in desalination devices. The resource of flowing fresh and salt water is abundant in certain coastal regions, while hot dry regions offer opportunities to use solar energy to continually concentrate the brine in salt ponds, making a stream of fresh water into a significant energy resource. The renewable energy potential from the environment is very great, and the above specification provides a basic roadmap for beginning to tap that potential.

Alternative details will be recognized for achieving the results described above. For example, sodium sulfate was chosen as an end-cell reagent of choice, while is it recognized that other anion species can be used to produce charge carriers to balance with the transported sodium ions. The nitrate ion in sodium nitrate is but one example. It is similarly recognized that where solar concentration provides highly concentrated ionic solutions but the environment provides brackish water rather than fresh water, hydrogen can be produced with the brackish water and concentrated brine rather than with fresh and salt water as described. Hence, one may consider the terms “fresh water” and “salt water” or “saline solution” to refer generally to a pair of solutions, the “fresh” one having a considerably lower ionic concentration than the “salty” or “saline” solution. These and other variations will be recognized as aspects of the same invention, which is described by the following claims.

I claim:

1. A salination hydrogen battery system comprising:
(a) a fresh water source providing fresh water;
(b) a saline solution source providing saline solution;
(c) a membrane stack comprising a plurality of adjacently spaced ion-selective permeable membranes, said membranes comprising cation-permeable membranes and anion-permeable membranes arranged in alternating order, whereby said membrane stack begins with a first of said cation-permeable membranes and ends with a last of said cation-permeable membranes;
(d) means for distributing said fresh water and said saline solution as alternating fluid layers between adjacent said ion-selective membranes;
(e) first and second end electrodes, said first end electrode spacedly located proximate said first cation-permeable membrane and said second end electrode spacedly located proximate said last cation-permeable membrane, thereby providing between each of said end electrodes and said membrane stack a first and a second end fluid cell, said two end electrodes being electrically connected for the passage of electrical current therebetween;
(f) each said end fluid cell comprising means to isolate fluid therein from said fluid layers between adjacent membranes;
(g) a reagent fluid circuit joining said end fluid cells; and
(h) gas collection means associated with at least one of said end fluid cells whereby hydrogen gas is generated electrolytically from at least one of said end electrodes, whereby said hydrogen gas is collected by said gas collection means, and whereby more than half the energy for said electrolytic generation derives from the thermodynamic energy of mixing of fluids from said fresh water source and said saline solution source.

2. The battery system of claim 1, further comprising means for electrolytic production of antimicrobial chemicals using said end electrodes.

3. The battery system of claim 2, further comprising means to circulate said antimicrobial chemicals between said membranes of said membrane stack.

4. The battery system of claim 1, further comprising means to selectively reverse said means for distributing said fresh water and said saline solution, whereby the passive direction of electrical current between said end electrodes is reversed.

5. A method for generating hydrogen gas from the energy of mixing of fresh water and saline solution, said method comprising the steps of:
(a) channeling anion migration in a first direction and cation migration in an opposite direction through use of ion-selective permeable membranes;
(b) generating an electrical potential and an associated ion current from said opposing anion and cation migrations;
(c) employing said electrical potential and said associated ion current for electrolytic separation of hydrogen gas from water.

6. The method of claim 5, further comprising the step of circulating a reagent solution, normally isolated from said fresh water and said saline solution, whereby said channeling of anion and cation migrations includes ion transport by the bulk flow of said reagent solution to and from the region of said electrolytic separation.
